(19) United States
(12) Patent Application Publication
(10) Pub. No.: US 2016/0320254 A1
(43) Pub. Date: Nov. 3, 2016

(54) Object Detection and Management System and Method

(71) Applicant: IGATE Global Solutions Ltd., Navi Mumbai, IN (US)

(72) Inventors: Madhusudhan Reddy Nukala, Navi Mumbai (IN); Avinash Babu Male, Navi Mumbai (IN); Hema C. Vadlamudi, Navi Mumbai (IN)

(21) Appl. No.: 14/755,300

(22) Filed: Jun. 30, 2015

(30) Foreign Application Priority Data
Apr. 29, 2015 (IN) 1707/MUM/2015

(51) Int. Cl. G01L 1/16; G06Q 10/08

(52) U.S. Cl. CPC G01L 1/16; G06Q 10/087

(57) ABSTRACT

A system has a plurality of pliable pressure sensitive sheets configured to be connected in series, and an electronic controller operatively coupled with the plurality of pressure sensitive sheets. The controller is configured to receive signals from the plurality of pressure sensitive sheets and determine the pressure applied to each of the pressure sensitive sheets based on signals it receives from the sheets.

### PRIORITY

This patent application claims priority from Indian Patent Application Number 1707/MUM/2015, filed Apr. 29, 2015, and entitled, “OBJECT DETECTION AND MANAGEMENT SYSTEM AND METHOD,” the disclosure of which is incorporated herein, in its entirety, by reference.

### FIELD OF THE INVENTION

The invention generally relates to object detection and management and, more particularly, the invention relates to pressure sensitive sheets and object management.

### BACKGROUND OF THE INVENTION

Effective inventory management can have a significant impact on retailer and wholesaler profitability. For example, if a retailer does not have an appropriate amount of product on the shelf, its customers may not buy products they intend to buy. Inventory tracking and monitoring thus has been a long-time challenge.

The art has responded to this using a variety of technologies, such as image recognition, RFID tags, and RFID radio signals, transmitters, and antennas. These known technologies, however, have deficiencies limiting their effectiveness, such as high cost, low reliability, difficulty in use, and/or limited scalability.

### SUMMARY OF THE INVENTION

In accordance with one embodiment of the invention, a system has a plurality of pliable pressure sensitive sheets configured to be connected in series, and an electronic controller operatively coupled with the plurality of pressure sensitive sheets. The controller is configured to receive signals from the plurality of pressure sensitive sheets and determine the pressure applied to each of the pressure sensitive sheets based on signals it receives from the sheets.

Each pressure sensitive sheet includes a pressure sensitive substrate that generates an electrical signal in response to receipt of a pressure, an input interface configured to receive an input signal from another serially connected pressure sensitive sheet, and an output interface configured to forward at least one output signal to another serially connected pressure sensitive sheet. The at least one output signal includes a local output signal generated in response to the amount of pressure applied to its pressure sensitive substrate. The plurality of pressure sensitive sheets includes a first pressure sensitive sheet serially connected with a second pressure sensitive sheet. The input interface of the first pressure sensitive sheet is unconnected to another pressure sensitive sheet, while the output interface of the first pressure sensitive sheet is electrically connected to the input interface of the second pressure sensitive sheet.

The electronic controller preferably has a plurality of controller inputs configured to receive the signals from the plurality of pressure sensitive sheets. For example, the plurality of inputs may include a plurality of independent inputs, a single interface logically partitioned into a plurality of inputs, or a single interface capable of receiving inputs from a plurality of sheets.

Among other things, the plurality of pressure sensitive sheets may be physically connected together. Alternatively, at least one of the plurality of pressure sensitive sheets may be wirelessly connected to at least one other of the plurality of pressure sensitive sheets.

To improve performance and usability, the plurality of pressure sensitive sheets may be flexible and can be folded between uses—it can be pliable too. Moreover, each pressure sensitive sheet may be configured to have the capability to receive a given number of input signals from one of the other pressure sensitive sheets when the system has the given number of pressure sensitive sheets. In addition, the electronic controller may include a microcontroller having a microcontroller interface electrically coupled with the outputs from a plurality of conditioning circuits. Each conditioning circuit may be coupled with one output interface of the same conductive sheet in the plurality of conductive sheets.

The pressure sensitive substrate may be implemented any of a variety of different technologies, such as a piezoelectric substrate. In some embodiments, the electronic controller is considered to have the role of a master and the plurality of pressure sensitive sheets are considered to have the roles of slaves. Thus, the electronic controller and plurality of pressure sensitive sheets form a master-slave relationship. Moreover, the plurality of serially connected pressure sensitive sheets may be configured to forward signal(s) from prior pressure sensitive sheet(s) without changing the forwarded signal(s).

Some embodiments configure the electronic controller to detect the presence of at least one object positioned on at least one of the pressure sensitive sheets based on signals received from the sheets. The electronic controller thus may be configured to determine the identity of the at least one pressure sensitive sheet based on the received signals. To that end, the electronic controller may produce one pressure reading for each of the plurality of pressure sensitive sheets. In addition, the electronic controller also typically is expected to be directly connected with an immediately prior pressure sensitive sheet. In that case, the immediately prior pressure sensitive sheet may be one of the plurality of pressure sensitive sheets and forwards a plurality of signals from the plurality of pressure sensitive sheets to the electronic controller. In other words, in that case, the immediately prior pressure sensitive sheet forwards signals from other sheets in the system.

In accordance with another embodiment of the invention, a method of determining the presence of one or more objects electrically connects a plurality of flexible pressure sensitive sheets in series. Each pressure sensitive sheet has a substrate that generates an electrical signal in response to receipt of a pressure. In addition, the method electrically connects an electronic controller to one of the plurality of pressure sensitive sheets, and places one or more objects on one or more of the plurality of pressure sensitive sheets. The objects on each pressure sensitive sheet produce an information signal indicative of the objects. Among other things, the information signal may include information relating to the weight or pressure produced by the objects. The electronic controller receives at least one information signal from the plurality of pressure sensitive sheets, and determines the total number of objects on each sheet based on the at least one information signal.

Other embodiments may implement the system as a kit for assembly.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a sensor system having objects on their faces and configured in accordance with illustrative embodiments of the invention.

FIG. 2 schematically shows more details of the sensor system of FIG. 1 in accordance of illustrative embodiments of the invention.

FIG. 3 schematically shows a single conductive sheet/sensor configured in accordance with illustrative embodiments of the invention.

FIG. 4 schematically shows a conditioning circuit for receiving signals from a single conductive sheet/sensor and configured in accordance with illustrative embodiments of the invention.

### DESCRIPTION OF ILLUSTRATIVE EMBODIMENTS

In illustrative embodiments, a robust sensor system is easily deployable and scalable at a reasonable cost. To that end, the sensor system includes a plurality of serially connected, flexible conductive sheets that each detects an object on its top surface. Each sheet forwards a signal to a destination electronic controller having logic for determining how many objects are supported by each sheet. Details of illustrative embodiments are discussed below.

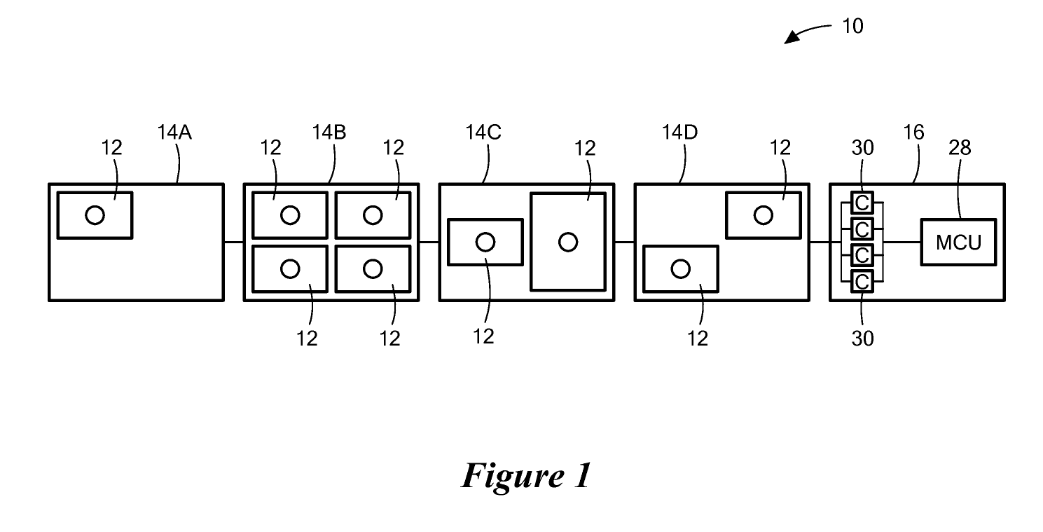

FIG. 1 schematically shows a top view of a system 10 that detects the presence of a plurality of objects 12. Specifically, the system 10 includes four serially connected conductive sheets 14A-14D (generally identified by reference number “14”), and a single electronic controller 16 connected in series to the last conductive sheet 14D. Among other things, the electronic controller 16 may be implemented as a conventional electronic controller, such as one or more of an application specific integrated circuit (i.e., “ASIC”), a digital signal processor (i.e., a “DSP”), a microprocessor, discrete hardware on a printed circuit board, software and/or firmware. For example, as known by those in the art, the electronic controller 16 may receive an input signal from a measured process variable (i.e., pressures on the sheets 14) and determine an output signal in response (i.e., the number of objects 12 on the sheets 14A-14D, discussed below).

Each sheet 14, which may be considered to form a sensor, preferably is formed from a pressure sensitive material that detects the aggregate pressure or weight supported on its top facing surface—i.e., pressure or weight of objects located within its footprint. Accordingly, each sheet 14 in this embodiment cannot detect the specific location or size of an object 12 within its footprint. Instead, each sheet 14 only can detect total pressure received at its face.

In the exemplary system 10 of FIG. 1, the first sheet 14A supports a single object 12, the second sheet 14B supports four objects 12 having identical footprints, the third sheet 14C supports two objects 12 having different footprints, and the fourth sheet 14D supports two objects 12 having the same footprints. It should be noted that although objects 12 can have the same footprints, they may have different weights depending upon their density, height, and physical make-up. Alternatively, different objects 12 having different footprints can have the same weight. The weight of each object 12 on a single sheet 14 provides a collective weight, which is sensed as a pressure on the face of each sheet 14. The piezoelectric nature of each sheet 14 causes it to produce an electronic signal that is transferred, in this example, through all intervening sheets 14 to the electronic controller 16 on the far right side.

As discussed in greater detail below, after receiving these signals from the sheets 14A-14D, the electronic controller 16 determines how many objects 12 are on each sheet 14. The objects 12 may be any object that can fit on the sheet 14 preferably without damaging itself or the sheet 14. For example, the object 12 may be a retail item, such as canned foods, bags of vegetables, shoe boxes, or other item. The object also may be human feet or a human body. In some embodiments, the electronic controller 16 has no information about the type of objects 12 supported by each of the conductive sheets 14. Accordingly, in that case, the electronic controller 16 simply receives an electronic signal indicating the total amount of pressure or weight on the sheets 14. The electronic controller 16 forwards this signal, sometimes with some pre-processing, to another device for further processing or display on a display device (e.g., using a graphical user interface).

Other embodiments of the electronic controller 16, however, have information about the types of objects 12 intended to be positioned on each sheet 14. For example, the electronic controller 16 may have information in memory indicating that the second sheet 14B is intended to have four objects 12 having identical weights and footprints. The electronic controller 16 also may have information relating to that weight. For space efficiency purposes, such a conductive sheet 14B may be sized just larger than the area cumulative footprint of the four objects 12. Accordingly, when the electronic controller 16 receives the electronic signal representing the second sheet 14B, this embodiment of the electronic controller 16 is configured to divide the total weight represented in the signal by the weight of a single unit of the object 12.

For example, the four objects 12 intended for the second sheet 14B may be shoe boxes having a weight of two pounds and a footprint of 1 foot by 1.5 feet. When the electronic controller 16 thus receives a signal indicating that the second sheet 14B is supporting a total of eight pounds, it can readily deduce that the second sheet 14B is supporting four of the indicated shoe boxes. As another example, if the fourth sheet 14D was intended to support the same shoe boxes, then the electronic controller 16 would receive a signal indicating a total weight of four pounds. As such, the electronic controller 16 could readily deduce that the fourth sheet 14D is supporting two shoe boxes. If a customer or other person removes one of those boxes, then the electronic controller 16 will detect a change in weight, indicating that that fourth sheet 14D now has one box only. A change in weight also may be accompanied by an alert signal, indicating a change in the weight on the sheet 14.

Indeed, some embodiments can configure the electronic controller 16 to determine the total number of objects 12 even when they are not identical. For example, illustrative embodiments of the electronic controller 16 can detect that the third sheet 14C has two different objects 12 that each have two different weights. Specifically, in this example, the third sheet 14C may be intended to hold two different types of objects 12 of different weights. The first object 12 may weigh five pounds while the second object 12 may weigh three pounds.

Accordingly, if the third sheet 14C sends a signal representing eight pounds, then the electronic controller 16 can deduce that the third sheet 14C supports both intended objects 12. Continuing with the same example, if the electronic controller 16 receives a signal representing three pounds, then it can deduce that the third sheet 14 C supports the three pound object 12 only. In a similar manner, if the electronic controller 16 receives a signal representing nine pounds, then it can deduce that the third sheet 14C supports three-three pound objects 12. Indeed, the electronic controller 16 can also determine other combinations depending upon the weight and footprints of the objects 12.

Those skilled in the art can program the electronic controller 16 to determine the number of objects 12 on the faces of the sheets 14 using any of a variety of conventional techniques. For example, the electronic controller 16 may access a look-up-table with different values/weights it may receive. The look-up-table then may indicate the total number of objects on the sheet 14. Other embodiments of the controller may apply an arithmetic operation to the received weight value, such as simply multiplying the weight by the ratio of the object to the weight (e.g. one object weighs 2 pounds, or 1 object/2 pounds).

In illustrative embodiments, the electronic controller 16 continuously monitors the signals it receives from the sheets 14A-14D. Accordingly, when it detects a change in pressure, the electronic controller 16 can update a database or other device with the change. A retailer, for example, then can replace the object 12 that was just removed with another object 12, efficiently and rapidly maintaining the object 12 on its shelf. Other embodiments, however, may periodically monitor the sheets 14A-14D. Those skilled in the art can configure the electronic controller 16 to manage the system 10 depending on the application and system requirements.

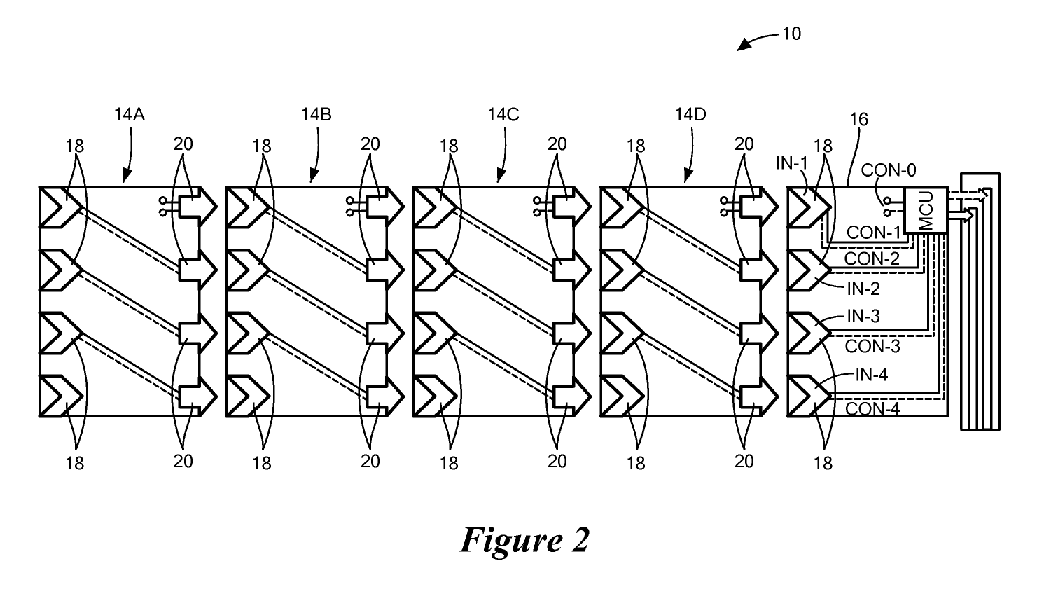

The sheets 14 preferably are connected in a manner that forwards signals directly to the electronic controller 16 through the other serially connected sheets 14. In the process, none of the signals may be conditioned or otherwise processed. Some embodiments, however, such as those having enough intervening conductive sheets 14 to degrade the signal, can have amplifiers along the way to amplify the sheet signals. FIG. 2 schematically shows the signal interfaces and transmission lines of the conductive sheets 14 to the electronic controller 16 in accordance with one embodiment of the invention.

As shown, each conductive sheet 14 has two interfaces; namely, an input interface (i.e., four inputs 18) and an output interface (i.e., four outputs 2). As noted, each of these inputs 18 and outputs 20 can generically be considered an interface. Accordingly, among other things, each interface may be implemented as separate physical components, a single component logically divided into four separate inputs 18, or a single input and/or output multiplexing input and/or output signals.

In this embodiment, the first three inputs 18, starting from top to bottom, each are connected via a transmission line (or other means, such as a wireless connection) with a corresponding output 20. Specifically, for a single sheet 14, the first input 18 is connected to the second output 20, the second input 18 is connected to the third output 20, and the third input 18 is connected to the fourth output 20. The fourth input 18 is a “dummy” input and is not connected to an output 20 having a signal—in this embodiment, such an input 18 forwards/transmits no actual signal. Instead, the fourth input 18 simply is a mechanical interface for connecting with the fourth output 20. Each conductive sheet 14 also has a single output 20 that is unconnected to any inputs 18. This single output 20, which from the perspective of the picture is near the top of the sheet 14, receives and transmits the actual pressure signal from its sheet 14 and forwards that signal to the first input 18 of its next adjacent sheet 14 in the series.

When mechanically connected, the inputs 18 may fit into the outputs 20 in a complimentary manner similar to puzzle pieces. To that end, the inputs 18, for example, may form protruding elements while the outputs 20 may form concave regions for receiving the protruding elements of the inputs 18. Clamps or similar mechanical fasteners may secure together adjacent sheets 14 (or an adjacent sheet 14 and controller 16) at the input/output interface, and/or at other parts of the adjacent sheets 14. Other embodiments may simply connect the inputs 18 and outputs 20 less directly, such as through one or more wires connecting between the inputs 18 and outputs 20 (e.g., using a wiring harness).

The electronic controller 16 in this embodiment has four corresponding inputs 18 for receiving the signals from each of the four sheets 14A-14D via the fourth sheet 14D. The top/first controller input 18 thus receives the pressure information from the fourth sheet 14D, the second controller input 18 receives pressure information relating to the third sheet 14C, the third controller input 18 receives pressure information relating to the second sheet 14B, and the fourth controller input 18 receives pressure information related to the first sheet 14A.

It should be noted that although the system 10 of FIGS. 1 and 2 has four pressure sensors implemented as sheets 14 that each have four inputs 18 and four outputs 20, those skilled in the art should understand that the system 10 can have different numbers of pressure sensitive sheets 14 having the same or different numbers of interfaces. For example, some embodiments may have two or three conductive sheets 14 that each respectively have two or three interfaces, or some embodiments may have two or three conductive sheets 14 that each have more than two or three interfaces. As a second example, some systems 10 may have 5, 10, 20, 50, 100, or more serially connected sheets 14 with appropriate numbers of interfaces. In fact, those sheets 14 in a single system 10 may each have different numbers of interfaces. Accordingly, discussion of a system 10 having four pressure sensitive sheets 14 that each have four inputs 18 and outputs 20 is for illustrative purposes only and not intended to limit various other embodiments of the invention.

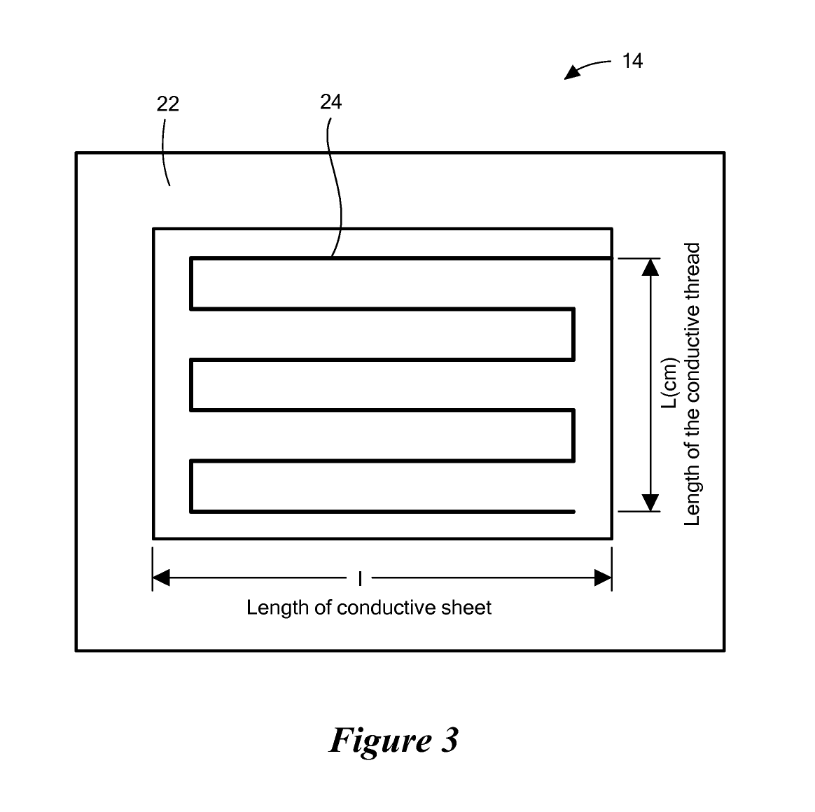

The pressure sensitive sheets 14 preferably are configured to be modular, highly scalable, and interchangeable with each other within a series of sheets 14. FIG. 3 schematically shows one embodiment of one pressure sensors sheet 14 configured in accordance with illustrative embodiments of the invention. The two-dimensional surface area of a given sheet 14 preferably is much larger than its cross-sectional thickness. This should present a surface that easily accommodates relevant objects 12.

As shown, each pressure sensitive sheet 14 has a piezoelectric, pressure sensitive surface or substrate 22 having an integrated conductive thread 24 in electrical communication with its interior. In illustrative embodiments, the conductive thread 24 is oriented in a serpentine shape to effectively detect pressure changes. The substrate 22 preferably is formed from a flexible/pliable and/or resilient material. Accordingly, the sheet 14 can be folded, rolled up, or otherwise bent and yet, still maintain its usability on a relatively flat surface.

More specifically, the sheet 14 may be considered to have two opposed surfaces and a small thickness between the two surfaces. The sheets 14 of FIG. 2, for example, show one of these surfaces, which may be considered to have a long dimension (i.e., top to bottom from the perspective of the drawing) and a short dimension (i.e., right to left from the perspective of the drawing). As its name suggests, each sheet 14 is quite thin compared to its length and width.

Moreover, as a foldable/bendable structure, the sheet 14 may be bent or folded across its thickness so that, from its top view, it may be manipulated from a first orientation, such as a flat orientation, to another orientation, such as a convex or convex orientation, and then to a third orientation (e.g., back to a flat orientation). As such, both the top and bottom surfaces bend/fold in a corresponding manner. For example, unlike a conventional scale, which is rigid with stiff mechanical elements (e.g., springs, gauges, etc.), the sheet 14 may be bent so that the top facing surface folds over on itself to have one end touch another end of the same surface. This may or may not produce a hinge that either is folded, arcuate, or some other shape, depending on the material used to form the sheet 14. Under normal use, such pliability/flexibility should not damage the sheet 14. As another example, in some embodiments, the sheet 14 is “rollable” so that it may be stored in a roll (e.g., like a roll of paper towels).

The materials forming a sheet 14 preferably are pliable enough so that it easily conforms to the shelf or surface upon which it is positioned. Other embodiments may be usable on an uneven surface having different levels. In that case, the sheet 14 may drape over the surface and take on the general contours of the underlying surface. In illustrative embodiments, the sheet 14 is formed from VELOSTAT material, distributed by 3M of Minneapolis, Minn. USA. For example, the sheet 14 may be formed from a polymeric or polyethylene film/foil (e.g., polyolefins) impregnated with carbon black or carbon fiber to make it electrically conductive. Another example may include LINQSTAT material, distributed by Caplinq Corporation of Canada. As noted above, other embodiments may be formed from an altogether different material. Accordingly the specific sheets mentioned above are for illustrative purposes only.

Each sheet 16 thus has a number of qualities that should optimize it for the desired application. For example, among other things, each sheet 14 may have one or more of the following qualities:
light weight,
durable/robust,
capable of withstanding high weights,
low cost,
low power, and
easy to couple with other sheets 14.

Receipt of a pressure on the substrate 22 causes a corresponding change in potential within the substrate 22, inducing a current signal through the conductive thread 24. This current passes through the conductive thread 24 and an output 20 of the pressure sensitive sheet 14.

Those skilled in the art should understand that the pressure sensors sheet 14 can take on any variety of form factors, and be made of a number of different types of devices. For example, the pressure sensors sheet 14 may be formed at least in part from an elastomeric material, a fabric, metal, or other material known in the art. In fact, rather than rely upon piezoresistance, some embodiments may rely on a different sensing modality, such as capacitive sensing or thermal detection, depending upon the object 12. Accordingly, discussion of the specific type of pressure sensors sheet 14 is for illustrative purposes only.

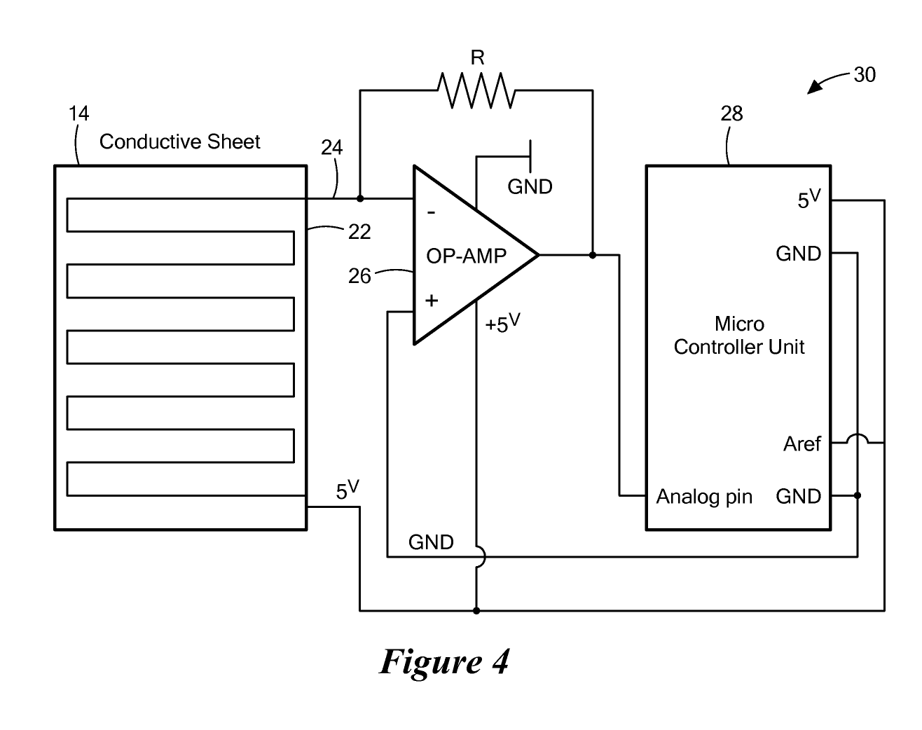

FIG. 4 schematically shows a conditioning circuit 30 that receives the output signal from one of the inputs 18 to the electronic controller 16. As shown, the output 20 from one of the sheets 14 is connected to the negative input of an operational amplifier 26. The output of the operational amplifier 26 connects with an analog pin of a microcontroller 28, which serves as the primary logical unit of the electronic controller 16. In the embodiments shown in FIGS. 1 and 2, the electronic controller 16 has four separate conditioning circuits 30 like the one shown in FIG. 4. Each of these conditioning circuits 30 connects with a separate analog pin on the microcontroller 28. Indeed, the circuit 30 may have other components not shown, such as long term and short term memory, additional microcontrollers, microprocessors, or application specific integrated circuits.

Accordingly, a user may effectively control inventory by connecting a series of sheets 14 and an interconnected controller 16 on a shelf or other surface, and then placing appropriate objects 12 on the top facing surfaces of the sheets 14. In fact, the user may position multiple sets of these serially connected pressure sensitive sheets 14 and electronic controllers 16 together to form a two-dimensional array that can receive a plurality of objects 12. Rather than using multiple sets of these systems 10, however, some instead may form the sheets to be much longer and wider to accommodate the additional objects 12.

Assuming the electronic controller 16 is configured and programmed with the appropriate data relating to the object(s) 12, the electronic controller 16 thus can immediately, or with some delay, determine the exact number of objects 12 on the sheets 14. This can be especially useful for a retailer. In fact, the user can fold or roll up the conductive sheets 14 between uses without risking significant damage. Illustrative embodiments therefore provide a relatively compact, robust, easily deployable, and scalable solution for inventory control not in use by the prior art (to the knowledge of the inventors).

Illustrative embodiments may be deployed in a number of different ways. For example, some embodiments may be deployed as a kit having the sheets 14, electronic controller 16, and other relevant portions of the system 10. The kit may have a plurality of sheets 14 stored in a stack or in a roll (e.g., like paper towels) to save space. In that case, the user may unroll the number of sheets 14 for the application, connect them in a conventional manner to each other and the electronic controller 16, and place them directly on a shelf or other surface for receiving objects. The pliability of the sheet 14 preferably enables the sheet 14 to conform to the surface upon which it is placed. After they are properly positioned, the user may place objects on the sheets 14 to manage inventory.

Although the above discussion discloses various exemplary embodiments of the invention, it should be apparent that those skilled in the art can make various modifications that will achieve some of the advantages of the invention without departing from the true scope of the invention.

What is claimed is:

1. A system comprising:
a plurality of pliable pressure sensitive sheets configured to be connected in series,
each pressure sensitive sheet including a pressure sensitive substrate that generates an electrical signal in response to receipt of a pressure, an input interface configured to receive an input signal from another serially connected pressure sensitive sheet, and an output interface configured to forward at least one output signal to another serially connected pressure sensitive sheet, the at least one output signal including a local output signal generated in response to the amount of pressure applied to its pressure sensitive substrate,
the plurality of pressure sensitive sheets including a first pressure sensitive sheet serially connected with a second pressure sensitive sheet, the input interface of the first pressure sensitive sheet being unconnected to another pressure sensitive sheet, the output interface of the first pressure sensitive sheet being electrically connectable to the input interface of the second pressure sensitive sheet,
an electronic controller operatively coupled with the plurality of pressure sensitive sheets, the electronic controller being configured to receive signals from the plurality of pressure sensitive sheets, the electronic controller being configured to determine the pressure applied to each of the pressure sensitive sheets based on the received signals.

2. The system as defined by claim 1 wherein the electronic controller has a plurality of electronic controller inputs configured to receive the signals from the plurality of pressure sensitive sheets.

3. The system as defined by claim 1 wherein the plurality of pressure sensitive sheets are physically connected together.

4. The system as defined by claim 1 wherein at least one of the plurality of pressure sensitive sheets is wirelessly connected to at least one other of the plurality of pressure sensitive sheets.

5. The system as defined by claim 1 wherein the plurality of pressure sensitive sheets can be folded between uses.

6. The system as defined by claim 1 wherein each pressure sensitive sheet is configured to have the capability to receive a given number of input signals from one of the other pressure sensitive sheets, the system having the given number of pressure sensitive sheets.

7. The system as defined by claim 1 wherein the electronic controller includes a microcontroller having a microcontroller interface electrically coupled with outputs from a plurality of conditioning circuits, each conditioning circuit coupled with one output interface of the same conductive sheet in the plurality of conductive sheets.

8. The system as defined by claim 1 wherein the pressure sensitive substrate comprises a piezoelectric substrate.

9. The system as defined by claim 1 wherein the electronic controller is a master and the plurality of pressure sensitive sheets are slaves, the electronic controller and plurality of pressure sensitive sheets forming a master-slave relationship.

10. The system as defined by claim 1 wherein the plurality of serially connected pressure sensitive sheets are configured to forward signal(s) containing data from prior pressure sensitive sheet(s) without changing the data contained forwarded signal(s).

11. The system as defined by claim 1 wherein the electronic controller is configured to detect the presence of at least one object positioned on at least one of the pressure sensitive sheets based on the received signals, the electronic controller being configured to determine the identity of the at least one pressure sensitive sheet based on the received signals.

12. The system as defined by claim 1 wherein the electronic controller produces one pressure reading for each of the plurality of pressure sensitive sheets.

13. The system as defined by claim 1 wherein the electronic controller is directly connected with an immediately prior pressure sensitive sheet, the immediately prior pressure sensitive sheet being one of the plurality of pressure sensitive sheets, the immediately prior pressure sensitive sheet forwarding a plurality of signals from the plurality of pressure sensitive sheets to the electronic controller.

14. A method of determining the presence of one or more objects, the method comprising:
electrically connecting a plurality of flexible pressure sensitive sheets in series, each pressure sensitive sheet having a substrate that generates an electrical signal in response to receipt of a pressure;
electrically connecting an electronic controller to one of the plurality of pressure sensitive sheets;
placing at least one object on one or more of the plurality of pressure sensitive sheets, the at least one object on each pressure sensitive sheet producing an information signal,
the electronic controller receiving at least one information signal from the plurality of pressure sensitive sheets; and
the electronic controller determining the total number of objects on each sheet based on the at least one information signal.

15. The method as defined by claim 14 wherein no object is simultaneously on two or more of the flexible pressure sensitive sheets.

16. The method as defined by claim 14 wherein each pressure sensitive sheet includes a pressure sensitive substrate, an input interface configured to receive an input signal from another serially connected pressure sensitive sheet, and an output interface configured to forward at least one output signal, the at least one output signal being generated by the pressure sensitive substrate in response to a pressure reading.

17. The method as defined by claim 14 further comprising providing a plurality of conditioning circuits, each conditioning circuit receiving an output signal from no more than one of the pressure sensitive sheets, each conditioning circuit forwarding a logic signal to the electronic controller.

18. The method as defined by claim 14 wherein the electronic controller has a plurality of controller inputs configured to receive the signals from the plurality of pressure sensitive sheets.

19. The method as defined by claim 14 wherein the plurality of pressure sensitive sheets are physically connected together.

20. The method as defined by claim 14 further comprising folding at least one pressure sensitive sheet.

21. The method as defined by claim 14 wherein the plurality of serially connected pressure sensitive sheets forward signals from prior pressure sensitive sheets without changing the forwarded signal.

22. The method as defined by claim 14 wherein each object has a known object weight, the electronic controller receiving a plurality of pressure signals, each pressure signal being from a different pressure sensitive sheet, the method dividing each pressure by the given object weight to produce an object count.

23. The method as defined by claim 22 further comprising forwarding the object count to a device.

24. The method as defined by claim 14 wherein the plurality of pressure sensitive sheets includes a first pressure sensitive sheet and a second pressure sensitive sheet, each of the first and second pressure sensitive sheets having an input interface and an output interface,
further wherein electrically connecting a plurality of pressure sensitive sheets comprises serially connecting the first pressure sensitive sheet to the second pressure sensitive sheet, the input interface of the first pressure sensitive sheet being unconnected to another pressure sensitive sheet, the output interface of the first pressure sensitive sheet being electrically connected to the input interface of the second pressure sensitive sheet.

25. An inventory control kit comprising:
a plurality of pliable pressure sensitive sheets configured to be serially connected,
each pressure sensitive sheet including a pliable pressure sensitive substrate that generates an electrical signal in response to receipt of a pressure, an input interface configured to receive an input signal from another serially connected pressure sensitive sheet, and an output interface configured to forward at least one output signal to another serially connected pressure sensitive sheet, the at least one output signal including a local output signal generated in response to the amount of pressure applied to its pressure sensitive substrate and
an electronic controller operatively couplable with the plurality of pressure sensitive sheets, the controller being configured to determine the pressure applied to each of the pressure sensitive sheets based on signals received from serially connected pressure sensitive sheets, the signals including at least one signal generated by each pressure sensitive substrate.

26. The kit as defined by claim 25 wherein the electronic controller has a controller interface, the kit further including a plurality of conditioning circuits configured to be electrically coupled with the outputs from a plurality of conditioning circuits, each conditioning circuit configured to be coupled with one output interface of no more than one conductive sheet in the plurality of conductive sheets.

27. The system as defined by claim 25 wherein the electronic controller has a plurality of controller inputs configured to receive signals from the plurality of pressure sensitive sheets.
